(19) United States
(12) Patent Application Publication
(10) Pub. No.: US 2012/0063719 A1
(43) Pub. Date: Mar. 15, 2012

(54) DWDM and CWDM Communication System over Multimode Fiber

(76) Inventors: Bogdan Chomycz, Thunder Bay (CA); Michael Andrew Tate, Hopkins, MN (US)

(21) Appl. No.: 12/879,628

(22) Filed: Sep. 10, 2010

(51) Int. Cl. G02B 6/28

(52) U.S. Cl. 385/24

(57) ABSTRACT

The transmission of multiple signals over multimode fiber is accomplished using single-mode transmission lasers and single-mode DWDM (Dense Wave Division Multiplexing) and CWDM (Coarse Wave Division Multiplexing) multiplexers. It also allows for any datarate communication, including high datarate (10 Gbps and faster) signals to be transported over any distance of multimode fiber. This ability will allow institutions that currently have multimode fiber in place, to extend the useful life of the fiber by increasing multimode fiber transmission capacity and thereby reducing overall infrastructure costs.

### FIELD OF THE INVENTION

The present invention relates to fiber optic communications and more specifically, to a system of transmitting and receiving multiple fiber optic signals over multimode optical fiber using DWDM or CWDM multiplexers.

### BACKGROUND OF THE INVENTION

Dense wavelength division multiplexing (DWDM) is a method of combining multiple signals that use lasers that use specific wavelengths for transmission along optical fiber. DWDM systems are a popular choice for metro and long-haul access networks on single-mode fiber, and major telecoms have a significant capital investment in the DWDM infrastructure. DWDM is widely deployed by major carriers due to the high density of channels per fiber, and because the distance can be greatly extended by amplifiers. As used herein, DWDM refers to an ITU standard in which the channel spacing of 200, 100, or 50 Ghz is used.

As used herein, a DWDM signal then would be any modulated optical signal at any datarate at a specific wavelength designed for transport through a DWDM multiplexer. This is different from a DWDM channel which as used herein, is an optical path that a specific wavelength of light travels through a DWDM multiplexer.

Course wavelength division multiplexing (CWDM) is a method of combining multiple signals that use lasers that use specific wavelengths for transmission along optical fiber, like DWDM. Also like DWDM, CWDM systems are a popular choice for metro networks on a single-mode fiber, and many smaller, regional, networks have a significant investment in CWDM infrastructure. CWDM is widely deployed because it has a lower initial capital investment over DWDM, but its disadvantages are that not as many channels can be deployed on a single fiber, and amplification is difficult, thus they are not used on longer-haul networks. As used herein, CWDM refers to an ITU standard in which the channel spacing is 20 nm from 1271 nm to 1611 nm.

As used herein, a CWDM signal then would be any modulated optical signal at any datarate at a specific wavelength designed for transport through a CWDM multiplexer. This is different from a CWDM channel which as used herein, is an optical path that a specific wavelength of light travels through a CWDM multiplexer.

DWDM and CWDM multiplexers are units that are capable of combining or separating numerous signals into and from a common aggregate fiber. There are four current methods of creating a DWDM or CWDM multiplexer. Those methods use: thin film filters (TFF), fiber Bragg gratings (FBG), array waveguide gratings (AWG), and diffraction grating filters (DF).

The most common is the thin film filter method. These filters allow a single band, or channel, to pass through them. Thus a DWDM or CWDM multiplexer is created by cascading a number of thin film filters together with the desired channel number. This works well for up to around 40 channels and is completely passive.

The second method of creating a DWDM or CWDM is to use a fiber Bragg grating. This method uses the fiber Bragg gratings and circulators in a similar cascaded method as with the TFF. But this is not as common as thin film filters because of the added cost of putting circulators. FBGs work well with up to 40 channels and are completely passive.

The third method of creating a DWDM or CWDM multiplexer is to use an array waveguide grating. This method uses an input coupler that splits the optical signal from the common fiber onto an arrayed waveguide. Here the optical signals experience a phase shift that creates an interference pattern at the output coupler, allowing individual channels to be directed to a single fiber. This technology is expensive, but it allows for very narrow channel spacing and high channel counts, and it is completely passive.

The fourth method of creating a DWDM or CWDM multiplexer is to use a diffraction grating filter. This method uses a diffraction grating to spatially separate out and combine the different wavelengths using the different angles of refraction that different wavelengths make at the grating. This method is expensive as well, but works well for high channel counts, and is completely passive

Single-mode fiber has been deployed in optical networks since the early 1980s, and it has become the most popular type of fiber for communications further than a kilometer. It serves as a waveguide to the signal, allowing only the first mode of the laser to propagate down its core. Single-mode fiber is distinguished because of its small core size between 7 and 10 micrometers in diameter.

Multimode fiber has been deployed in networks since 1977 and was the first fiber optic technology to be introduced to the industry. It still maintains popularity among networks where the distances are between 0 and 2000 meters because of the inexpensive nature of the equipment associated with it. Multimode fiber is distinguished by its large core size from 100 to 50 micrometers in diameter.

Bandwidth requirements have forced network administrators who have multimode networks to scramble to meet those demands. Their only options were to increase the datarate or install more fiber. But both options can be unfeasible due to limitations on distance for higher data rates, or the high costs associated with new installations and the possible destruction of landscaping, parking lots, etc.

What is needed is a method of multiplexing DWDM or CWDM signals onto a multimode fiber at all data rates.

### BRIEF DESCRIPTION OF THE DRAWINGS

Examples of the present invention are illustrated in the accompanying drawings. The accompanying drawings, however, do not limit the scope of the present invention. Similar references in the drawings indicate similar elements.

FIG. 1 is a block diagram of how the DWDM or CWDM multiplexer would be connected to a single multimode fiber to achieve uni-directional communication.

FIG. 2 is a block diagram of how the DWDM or CWDM multiplexer would be connected to a single multimode fiber to achieve bi-directional communication.

FIG. 3 is a block diagram of how the DWDM or CWDM multiplexer would be connected to two multimode fibers to achieve bi-directional communication.

### DETAILED DESCRIPTION OF THE INVENTION

The invention described involves optical communications, specifically, it involves a system that integrates single-mode CWDM or DWDM multiplexers onto multimode fiber that will provide for the ability to increase bandwidth without having to replace existing multimode fiber infrastructure.

In this description, references will be made to the drawings to illustrate particular elements of this invention and the method in which it is implemented. It is to be understood that minor changes in the configuration can be made to the following system without deviating from the scope of this invention.

FIG. 1 illustrates a simple uni-directional DWDM optical system 100 that includes a single-mode fiber DWDM multiplexer 101 with a common port 102. At the other end is a single-mode fiber DWDM demultiplexer 103 with a common port 104. Joining the two common ports 102 and 104 is a multimode fiber 105. This multimode fiber can be of any core size greater than 10 micrometers in diameter, including 50, 62.5, and 100 micrometers in diameter. The plurality of DWDM signals is generally indicated by 110, and represents input channels into the DWDM, at any spacing, including 200, 100, 50, or 25 Ghz as defined by ITU documents, but not restricted to these channel spacings.

In FIG. 1, each signal is generated by a single-mode DWDM modulated laser and propagates from 110 at a specific, unique, wavelength. This signal then propagates into the DWDM multiplexer 101 into a port specific to that wavelength over a single-mode fiber. In multiplexer 101, the signal is multiplexed with the other signals connected to other multiplexer ports at different wavelengths onto the common fiber at the common port 102. The signal then travels over any length of multimode fiber 105 into common port 104. Here the signals in the common fiber are broken up into individual signals and exit the de-multiplexer 103 as signal 111 over single-mode fiber in separate ports specific to that signal's wavelength, where it is received by an optical receiver.

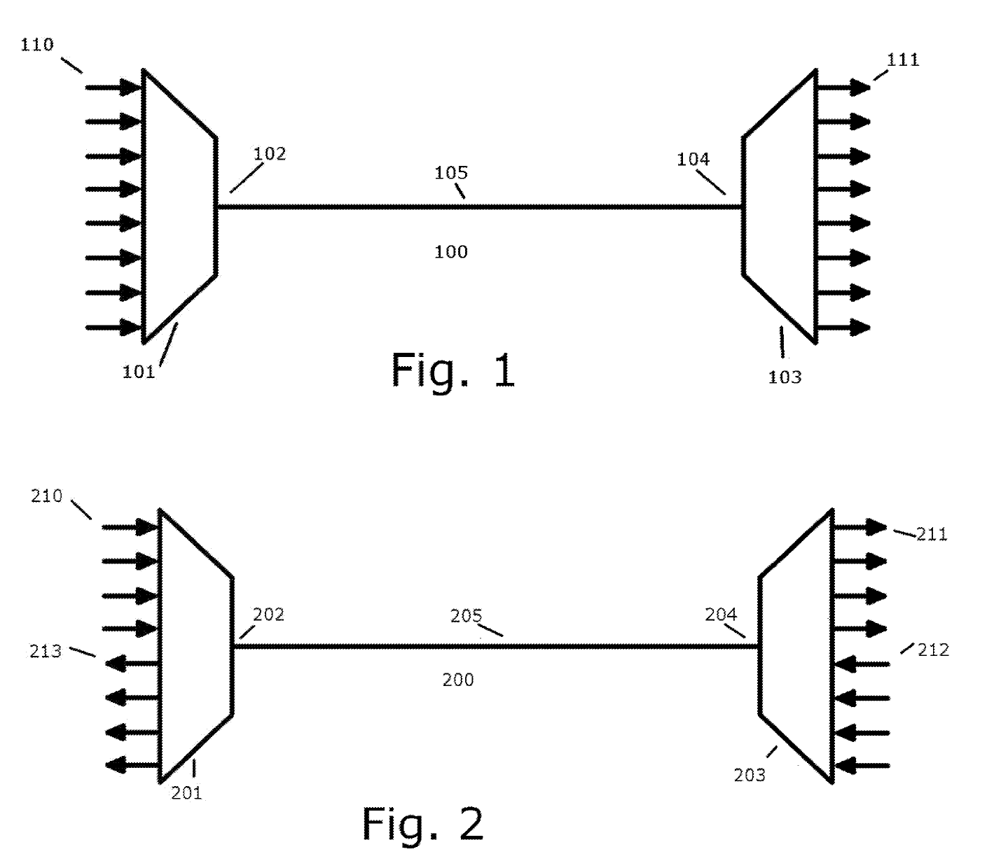

This concept can be extended to create a bi-directional DWDM optical system as indicated by FIG. 2. In this figure, a simple bi-directional DWDM optical system 200 is shown that includes a single-mode fiber DWDM multiplexer 201, henceforth referred to as “West”, with a common port 202. At the other end is an identical single-mode fiber DWDM multiplexer 203, henceforth referred to as “East”, with a common port 204. Joining the two common ports is any length of multimode fiber 205. This multimode fiber can be of any core size greater than 10 micrometers in diameter, including 50, 62.5, and 100 micrometers in diameter. The plurality of DWDM signals traveling from “West to East” are generally indicated by 210 and the plurality of DWDM signals traveling from “East to West” are generally indicated by 212. These signals represent channels spaced at 200, 100, 50, or 25 Ghz as defined by ITU documents, but not restricted to these channel spacings.

In FIG. 2, each signal is generated by a single-mode DWDM modulated laser and propagates from 210 at a specific, unique, wavelength. This signal then propagates into the DWDM multiplexer 201 into a port specific to that wavelength over a single-mode fiber. In multiplexer 201, the signal is multiplexed with the other signals connected to other multiplexer ports at different wavelengths onto the common fiber at the common port 202. The signal then travels over multimode fiber 205 into common port 204. Here the signals in the common fiber are broken up into individual channels and exit the de-multiplexer 203 as signal 211 over single-mode fiber, where it is received by an optical receiver. Then in the other direction, each signal is generated by a single-mode DWDM modulated laser and propagates from 212 at a specific, unique, wavelength. This signal then propagates into the DWDM multiplexer 203 into a port specific to that wavelength over a single-mode fiber. In multiplexer 203, the signal is multiplexed with the other signals connected to other multiplexer ports at different wavelengths onto the common fiber at the common port 204. The signal then travels over multimode fiber 205 into common port 202. Here the signals in the common fiber are broken up into individual channels and exit the de-multiplexer 201 as signal 213 over single-mode fiber, where it is received by an optical receiver.

It should be noted here that bi-directional communication is possible over one fiber because the light traveling in the fiber is able to travel in both directions.

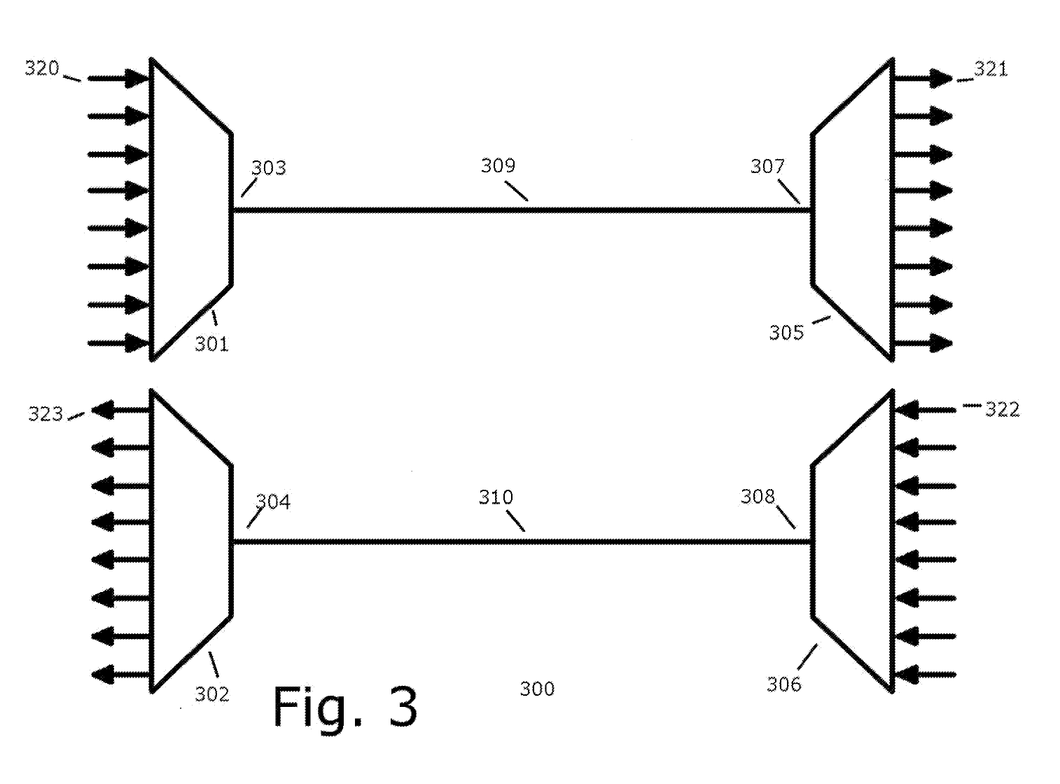

Taking the bi-directional system and extending it to a system with two available fibers is indicated by FIG. 3. In this figure, a simple bi-directional DWDM optical system 300 is shown using two fibers. 301 is a single-mode fiber DWDM multiplexer and 302 is a single-mode fiber DWDM de-multiplexer. Both of these will be on the “West” side of the system. 301 has a common port 303 and 302 has a common port 304. On the “East” side is 305, a DWDM de-multiplexer and 306, a DWDM multiplexer. 305 has a common port 307, and 306 has a common port 308. Joining common ports 303 and 307 is a multimode fiber 309; and joining common ports 304 and 308 is a multimode fiber 310. These multimode fibers can be of any core size greater than 10 micrometers in diameter, including 50, 62.5, and 100 micrometers in diameter.

The plurality of DWDM signals traveling from “West to East” are generally indicated by 320, and the plurality of DWDM signals traveling from “East to West” are generally indicated by 321. These signals represent channels spaced at 200, 100, 50, or 25 Ghz as defined by ITU documents, but not restricted to these channel spacings.

In FIG. 3, each signal is generated by a single-mode DWDM modulated laser and propagates from 320 at a specific, unique, wavelength. This signal then propagates into the DWDM multiplexer 301 into a port specific to that wavelength over a single-mode fiber. In multiplexer 301, the signal is multiplexed with the other signals connected to other multiplexer ports at different wavelengths onto the common fiber at the common port 302. The signal then travels over multimode fiber 309 into common port 307. Here the signals in the common fiber are broken up into individual channels and exit the de-multiplexer 305 as signal 321 over single-mode fiber, where it is received by an optical receiver. Then in the other direction, each signal is generated by a single-mode DWDM modulated laser and propagates from 322 at a specific, unique, wavelength. This signal then propagates into the DWDM multiplexer 306 into a port specific to that wavelength over a single-mode fiber. In multiplexer 306, the signal is multiplexed with the other signals connected to other multiplexer ports at different wavelengths onto the common fiber at the common port 308. The signal then travels over multimode fiber 310 into common port 302. Here the signals in the common fiber are broken up into individual channels and exit the de-multiplexer 301 as signal 323 over single-mode fiber, where it is received by an optical receiver.

In FIG. 3. where a multiplexer and de-multiplexer are on the same side to achieve bi-directional communication over two fibers, it can save space to place the multiplexer and de-multiplexer in the same contained unit.

It should also be noted that in all three figures, the DWDM multiplexers and de-multiplexers can be replaced with single-mode CWDM multiplexers and de-multiplexers. And as long as the signals entering the multiplexers are of CWDM wavelengths (or certain DWDM wavelengths that work on CWDM channels), the systems will work just as described above for DWDMs.

What is claimed is:

1. A fiber optic system between two locations, where the two locations are connected physically by a multimode fiber, using a single-mode fiber dense wavelength division multiplexing (DWDM) multiplexer at the near end of the system, having a plurality of single-mode fiber DWDM signal inputs and a common signal output which the plurality of signals are combined onto a multimode fiber; and a single-mode fiber DWDM demultiplexer at the far end of the multimode fiber, having an input coupled to the multimode common fiber as well as DWDM outputs for a plurality of single-mode fiber DWDM signals.

2. The fiber optic system in claim 1, wherein said single-mode DWDM multiplexer contains both the multiplexer and demultiplexer in the same contained unit for bi-directional transmission over two multimode fibers.

3. The fiber optic system in claim 1, wherein the single-mode DWDM multiplexer has any number of channels.

4. The fiber optic system in claim 1, wherein said single-mode DWDM multiplexer has any channel spacing including 200 Ghz, 100 Ghz, 50 Ghz, and 25 Ghz from 1260 nm to 1675 nm.

5. The fiber optic system in claim 1, wherein the plurality of DWDM signals each comprise of laser optical signal of any transmission rate and any protocol.

6. The fiber optic system in claim 1, wherein the signals are able to propagate over any distance of multimode fiber.

7. The fiber optic system in claim 1, wherein the common fiber is comprised of any multimode fiber, including 50/125, 62.5/125, or 100/125 multimode fiber

8. The fiber optic system in claim 1, wherein the plurality of inputs to the DWDM multiplexer are sourced from single-mode transmission lasers

9. The fiber optic system in claim 1, wherein the plurality of outputs from the DWDM demultiplexer are transmitted to receivers designed to receive single-mode transmissions

10. The fiber optic system in claim 1, wherein the connections between the transmission lasers and plurality of DWDM multiplexer inputs are made with single-mode fiber

11. The fiber optic system in claim 1, wherein the connections between the receivers and plurality of DWDM demultiplexer outputs are made with single-mode fiber.

12. The fiber optic system in claim 1, wherein the single-mode DWDM multiplexers are replaced with single-mode CWDM multiplexers.

13. The fiber optic system in claim 12, wherein said single-mode CWDM multiplexer contains both the multiplexer and demultiplexer in the same contained unit for bi-directional transmission over two fibers.

14. The fiber optic system in claim 12, wherein the single-mode CWDM multiplexer has any number of channels.

15. The fiber optic system in claim 12, wherein said single-mode CWDM multiplexer has any channel spacing, including ITU-T channel spacing of 20 nm from 1271 nm to 1611 nm.

16. The fiber optic system in claim 12, wherein the plurality of DWDM signals each comprise of laser optical signal of any transmission rate and any protocol

17. The fiber optic system in claim 12, wherein the signals are able to propagate over any distance of multimode fiber.

18. The fiber optic system in claim 12, wherein the common fiber is comprised of multimode fiber, including 50/125, 62.5/125, or 100/125 multimode fiber

19. The fiber optic system in claim 12, wherein the plurality of inputs to the CWDM multiplexer are sourced from single-mode transmission lasers

20. The fiber optic system in claim 12, wherein the plurality of outputs from the CWDM demultiplexer are transmitted to receivers designed to receive single-mode transmissions

21. The fiber optic system in claim 12, wherein the connections between the transmission lasers and plurality of CWDM multiplexer inputs are made with single-mode fiber

22. The fiber optic system in claim 12, wherein the connections between the receivers and plurality of CWDM demultiplexer outputs are made with single-mode fiber.
